(19) United States
(12) Patent Application Publication
(10) Pub. No.: US 2004/0013274 A1
(43) Pub. Date: Jan. 22, 2004

(54) Circuit for providing a high-voltage audio signal to an electrostatic loudspeaker and method of operating the same

(76) Inventors: Leon M. Bellan, Pasadena, CA (US); Paul M. Bellan, Pasadena, CA (US)

Correspondence Address: Daniel L. Dawes, Myers Dawes Andras & Sherman LLP, Suite 1150, 19900 MacArthur Boulevard, Irvine, CA, 92612, US

(21) Appl. No.: 10/461,756

(22) Filed: Jun. 13, 2003

Related U.S. Application Data
(60) Provisional application No. 60/388,884, filed on Jun. 13, 2002.

(51) Int. Cl. H04B 3/00; H04B 5/00

(52) U.S. Cl. 381/77; 381/79; 381/116

(57) ABSTRACT

This disclosure relates to a design for the circuit required to drive electrostatic loudspeakers. Such speakers require a high voltage audio signal, typically generated using a wideband, high power step-up transformer. The design eliminates the requirement for such a transformer by mixing the audio frequency signal with a high frequency carrier. This modulated signal may then be amplified and transformed to a high voltage signal using a much more modest transformer operating at the carrier frequency. A simple detection circuit then recovers the original audio waveform from the modulated signal and drives the electrostatic loudspeaker. Such a circuit may be cheaper than a wideband transformer and may also improve the frequency response of the driving electronics.

### RELATED APPLICATIONS

The present application is related to U.S. Provisional Patent Application serial No. 60/388,884, filed on Jun. 13, 2002, which is incorporated herein by reference and to which priority is claimed pursuant to 35 USC 119.

### BACKGROUND OF THE INVENTION

1. Field of the Invention

The invention relates to the field of drives for electrostatic loudspeakers, and in particular to speaker drives without wideband, high power step-up transformers.

2. Description of the Prior Art

Electrostatic loudspeakers generate sound by moving a thin stretched membrane (diaphragm) under the influence of an oscillating electric field. The membrane is conductive and charge is placed on it by means of a high-voltage DC supply. The charge, embedded in the membrane, feels a force due to the electric field and thus moves, dragging the membrane with it. The membrane moves the air around it, and acoustic waves are generated. The oscillating electric field is generated by two pieces of perforated (so as to be acoustically transparent) sheet metal (stators) across which the high voltage audio signal is placed. This entire system is rather different than typical dynamic speakers, which rely on a coil moving in a magnetic field to produce movement of the diaphragm. Electrostatic loudspeakers use a very thin diaphragm and are thus able to achieve much better high-frequency response than conventional dynamic loudspeakers. Electrostatic loudspeakers are typically found in high fidelity audio systems.

In order to create a strong electric field between the stators, a large voltage must be applied between them. The voltages required (several kilovolts) are not easily generated by conventional audio equipment. Common electrostatic loudspeakers rely on a wide-band, high power, well insulated step-up transformer to convert the signal from a standard audio amplifier into the high-voltage signal required by the electrostatic loudspeaker. These transformers are expensive, and may have poor frequency response. What is needed is a design that does not require the use of such a transformer.

### BRIEF SUMMARY OF THE INVENTION

In order allow the use of a smaller, more efficient step-up transformer, in the circuit of the invention, the audio signal is mixed with a high-frequency carrier signal, using, for example, amplitude, frequency, or pulse-width modulation, which is amplified, and then sent to a high-frequency transformer to increase the voltage. Since this pre-processed signal is now at a higher frequency and thus the fractional variation in frequency due to modulation is very small, the requirements for the high frequency transformer are much more modest. The transformer should preferably still be able to handle high voltages (several kilovolts) and high power (approximately 100 W), but this is easier to obtain at higher frequencies. The transformer need only have a flat frequency response in the small region near the carrier, and thus need not be a wideband transformer.

Thus, the invention is defined as a circuit for driving an electrostatic loudspeaker from a source of an audio signal comprising: a source of a high frequency carrier signal; a mixer coupled to the source of the audio signal and the high frequency carrier signal to produce a modulated signal; an amplifier coupled to the mixer; a transformer coupled to the amplifier for stepping up the amplified modulated signal to a high voltage modulated signal, the transformer having a high voltage output coupled to the electrostatic loudspeaker; and a demodulator coupled to the transformer to recover the audio signal to drive the electrostatic loudspeaker.

In another embodiment the invention is a circuit for driving an electrostatic loudspeaker from a source of an audio signal comprising: a source of a high frequency carrier signal; an amplifier coupled to the source of a high frequency carrier signal; a mixer coupled to the amplifier to produce a modulated high frequency signal; a transformer coupled to the mixer for stepping up the amplified modulated signal to a high voltage modulated signal, the transformer having a high voltage output coupled to the electrostatic loudspeaker; and a demodulator coupled to the transformer to recover the audio signal to drive the electrostatic loudspeaker.

In still another embodiment the invention is a circuit for driving an electrostatic loudspeaker from a source of an audio signal comprising: a source of a high frequency, high power carrier signal; a mixer coupled to the source of the audio signal and to the source of a high frequency, high power carrier signal to mix the audio signal with the high frequency, high power carrier signal; a transformer coupled to the mixer to transforms the modulated signal to a high voltage signal; and a demodulator to recover the audio signal, and to drive the electrostatic loudspeaker with the recovered audio signal.

In yet another embodiment the invention is defined as an active electrostatic loudspeaker assembly for combination with a line-level audio signal source comprising as a single unit: an electrostatic loudspeaker; and a drive circuit capable of driving the electrostatic loudspeaker from a line-level audio signal source without amplification in which drive circuit the line-level audio signal from the line-level audio signal source is mixed with a carrier, amplified, to a high frequency modulated signal, transformed to a high voltage modulated signal, and demodulated to drive the electrostatic loudspeaker at high voltage.

The demodulator may comprise a detector and a filter to process the frequency of the demodulated high voltage signal driving the electrostatic speaker.

The invention is also a method of driving an electrostatic loudspeaker comprising the steps of mixing a line-level audio signal with a high frequency carrier; transforming the high frequency modulated signal into a high voltage, high frequency modulated signal in a transformer; and demodulating the high voltage, high frequency modulated signal to drive the electrostatic loudspeaker at high voltage. The method further comprises the step of amplifying the high frequency signal. The step of mixing a line-level audio signal with a high frequency carrier can be performed before or after the step of amplifying the high frequency modulated signal.

In one embodiment the step of demodulating the high voltage, high frequency modulated signal to drive the electrostatic loudspeaker at high voltage comprises the steps of detecting the high voltage, high frequency modulated signal to recover the audio signal, signal shaping the recovered audio signal, and driving the electrostatic speaker therewith.

The step of mixing a line-level audio signal with a high frequency carrier comprises the step of amplitude modulating, frequency modulating or pulse-width modulating the high frequency carrier signal.

The step of mixing a line-level audio signal with a high frequency carrier mixes the audio signal with a high frequency carrier as a frequency high enough so that the modulation bandwidth is substantially included entirely within a substantially flat bandpass of the transformer.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a simplified block diagram of conventional prior art electrostatic loudspeaker system employing a wideband transformer to obtain the high voltage audio signal.

FIG. 2 is a simplified block diagram of one embodiment of the circuit of the invention used for driving an electrostatic loudspeaker using a modulated signal and a narrow-band high-frequency step-up transformer.

FIG. 3 is a simplified block diagram of another embodiment of the circuit of the invention used for driving an electrostatic loudspeaker using a modulated signal and a narrow-band high-frequency step-up transformer.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

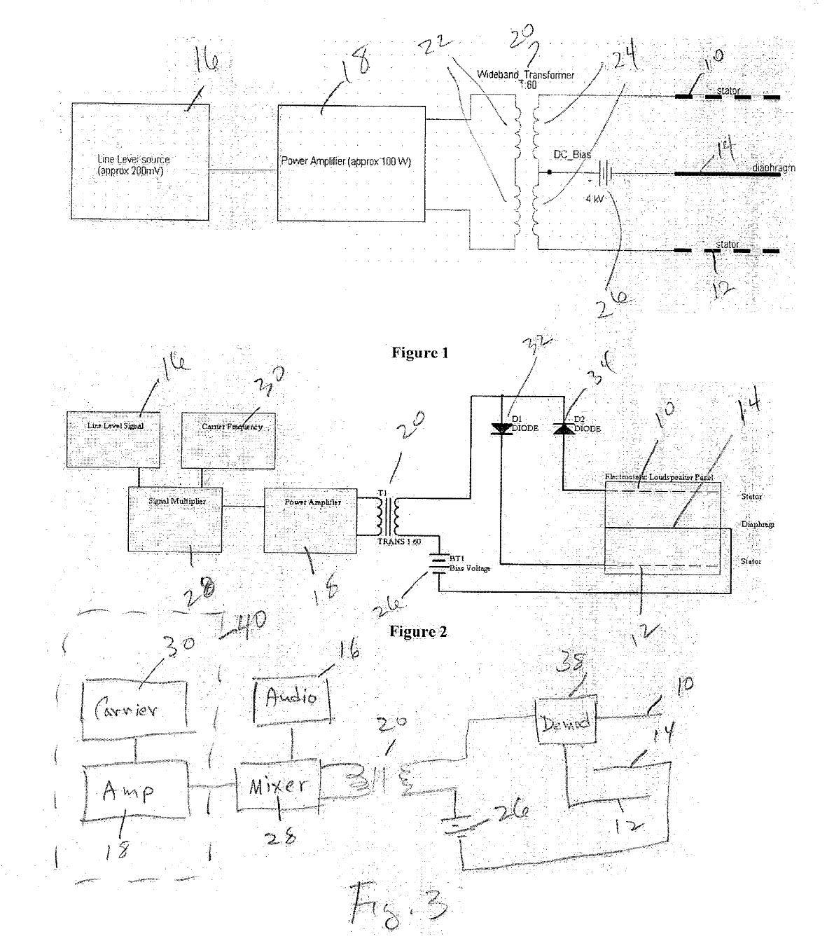

FIG. 1 is a prior block diagram of a prior art circuit for driving an electrostatic speaker, here symbolic referenced by two stators 10 and 12 with an interacting diaphragm 14. The audio signal is provided by a line level source 16, which typically has an average magnitude of about 200 mV. Line level source 16 is coupled to a power amplifier 18 which has an output power of about 100W. Power amplifier 18 is coupled to the primary coils 22 of a 1:60 wideband transformer 22 and transformed up in voltage to secondary coils 24 which are coupled to stators 10 and 12 and center-tapped to diaphragm 14 through a 4 kV DC bias source 26.

The illustrated embodiment of the invention is shown in the simplified block circuit diagram of FIG. 2, and operates as follows. The audio signal is obtained from line-level source 16 as in the prior art. This signal is used to modulate the amplitude of a carrier signal obtained from carrier frequency source 30, which carrier frequency oscillating at a higher frequency (for example, approximately 1 MHz) in a fashion similar to an AM radio station. The modulating signal from line level source 16 and carrier frequency source 30 are combined in signal multiplier 28. Other frequencies can be substituted and other modulation schemes employed without departing from the scope of the invention. The modulated carrier is amplified using a high-frequency power amplifier 18. The amplified modulated signal is sent through step up transformer 20 (for example, turns ratio approximately 1:60) designed to operate at the carrier frequency, turning it into a high voltage signal at several kilovolts.

The high voltage AM signal is detected using high-voltage diodes 32 and 34 coupled to one end of transformer secondary coil 24 and is used to power the stators 10 and 12 of electrostatic speaker 36. Diodes 32 and 34 are reversed with respect to each other so that one of them conducts on the positive cycles and the other conducts on the negative cycles. Diodes 32 and 34 are each coupled to opposing ones of the two stators 10 and 12. Diodes 32 and 34 thus comprise a very simple demodulation circuit 38. Diaphragm 14 is coupled to DC bias source 26 which is coupled to the opposed end of transformer secondary coil 24. In this case no centertap on transformer 20 is used.

Aspects of this design that may easily be modified to suit the electrostatic panel include the turns ratio of the transformer 20, the power rating of the amplifier 18, and the frequency of the carrier. The demodulation circuit 38 used for detection may be made more complex by including DC-blocking capacitors and/or capacitors used as low-pass filters (not shown) for smoothing the waveform in place of diodes 32 and 34. It is also possible to switch the order of the amplifier 18 and modulating circuit 28; in such a setup the carrier frequency is amplified and then mixed with the line-level signal as diagrammatically shown in FIG. 3. It is still further possible to combine the source of the high frequency carrier signal and the amplifier into a circuit element or into a source 40 of a high frequency, high power carrier signal.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

I claim:

1. A circuit for driving an electrostatic loudspeaker from a source of an audio signal comprising:
a source of a high frequency carrier signal;
a mixer coupled to the source of the audio signal and the high frequency carrier signal to produce a modulated signal;
an amplifier coupled to the mixer;
a transformer coupled to the amplifier for stepping up the amplified modulated signal to a high voltage modulated signal, the transformer having a high voltage output coupled to the electrostatic loudspeaker; and
a demodulator coupled to the transformer to recover the audio signal to drive the electrostatic loudspeaker.

2. A circuit for driving an electrostatic loudspeaker from a source of an audio signal comprising:
a source of a high frequency carrier signal;
an amplifier coupled to the source of a high frequency carrier signal;
a mixer coupled to the amplifier to produce a modulated high frequency signal;
a transformer coupled to the mixer for stepping up the amplified modulated signal to a high voltage modulated signal, the transformer having a high voltage output coupled to the electrostatic loudspeaker; and
a demodulator coupled to the transformer to recover the audio signal to drive the electrostatic loudspeaker.

3. A circuit for driving an electrostatic loudspeaker from a source of an audio signal comprising:
a source of a high frequency, high power carrier signal;
a mixer coupled to the source of the audio signal and to the source of a high frequency, high power carrier signal to mix the audio signal with the high frequency, high power carrier signal;
a transformer coupled to the mixer to transforms the modulated signal to a high voltage signal; and
a demodulator to recover the audio signal, and to drive the electrostatic loudspeaker with the recovered audio signal.

4. An active electrostatic loudspeaker assembly for combination with a line-level audio signal source comprising as a single unit:
an electrostatic loudspeaker; and
a drive circuit capable of driving the electrostatic loudspeaker from a line-level audio signal source without amplification in which drive circuit the line-level audio signal from the line-level audio signal source is mixed with a carrier, amplified, to a high frequency modulated signal, transformed to a high voltage modulated signal, and demodulated to drive the electrostatic loudspeaker at high voltage..

5. The active electrostatic loudspeaker assembly of claim 4 where the drive circuit comprises:
a source of a high frequency carrier signal;
a mixer coupled to the source of the audio signal and the high frequency carrier signal to produce a modulated signal;
an amplifier coupled to the mixer;
a transformer coupled to the amplifier for stepping up the amplified modulated signal to a high voltage modulated signal, the transformer having a high voltage output coupled to the electrostatic loudspeaker; and
a demodulator coupled to the transformer to recover the audio signal to drive the electrostatic loudspeaker.

6. The active electrostatic loudspeaker assembly of claim 4 where the drive circuit comprises:
a source of a high frequency carrier signal;
an amplifier coupled to the source of a high frequency carrier signal;
a mixer coupled to the amplifier to produce a modulated high frequency signal;
a transformer coupled to the mixer for stepping up the amplified modulated signal to a high voltage modulated signal, the transformer having a high voltage output coupled to the electrostatic loudspeaker; and
a demodulator coupled to the transformer to recover the audio signal to drive the electrostatic loudspeaker.

7. The active electrostatic loudspeaker assembly of claim 4 where the drive circuit comprises:
a source of a high frequency, high power carrier signal;
a mixer coupled to the source of the audio signal and to the source of a high frequency, high power carrier signal to mix the audio signal with the high frequency, high power carrier signal;
a transformer coupled to the mixer to transforms the modulated signal to a high voltage signal; and
a demodulator to recover the audio signal, and to drive the electrostatic loudspeaker with the recovered audio signal.

9. The circuit of claim 1 where the demodulator comprises a detector and a filter to process the frequency of the demodulated high voltage signal driving the electrostatic speaker.

10. The circuit of claim 2 where the demodulator comprises a detector and a filter to process the frequency of the demodulated high voltage signal driving the electrostatic speaker.

11. The circuit of claim 3 where the demodulator comprises a detector and a filter to process the frequency of the demodulated high voltage signal driving the electrostatic speaker.

12. A method of driving an electrostatic loudspeaker comprising:
mixing a line-level audio signal with a high frequency carrier;
transforming the high frequency modulated signal into a high voltage, high frequency modulated signal in a transformer; and
demodulating the high voltage, high frequency modulated signal to drive the electrostatic loudspeaker at high voltage.

13. The method of claim 12 further comprising amplifying the high frequency signal.

14. The method of claim 13 where mixing a line-level audio signal with a high frequency carrier is performed before amplifying the high frequency modulated signal.

15. The method of claim 13 where mixing a line-level audio signal with a high frequency carrier is performed after amplifying the high frequency signal.

16. The method of claim 12 where demodulating the high voltage, high frequency modulated signal to drive the electrostatic loudspeaker at high voltage comprises detecting the high voltage, high frequency modulated signal to recover the audio signal, signal shaping the recovered audio signal, and driving the electrostatic speaker therewith.

17. The method of claim 12 where mixing a line-level audio signal with a high frequency carrier comprising amplitude modulating the high frequency carrier signal.

18. The method of claim 12 where mixing a line-level audio signal with a high frequency carrier comprising frequency modulating the high frequency carrier signal.

19. The method of claim 12 where mixing a line-level audio signal with a high frequency carrier comprising pulse-width modulating the high frequency carrier signal.

20. The method of claim 12 where mixing a line-level audio signal with a high frequency carrier mixes the audio signal with a high frequency carrier as a frequency high enough so that the modulation bandwidth is substantially included entirely within a substantially flat bandpass of the transformer.
